(19) United States
(12) Patent Application Publication
(10) Pub. No.: US 2014/0159627 A1
(43) Pub. Date: Jun. 12, 2014

(54) MOTOR DRIVING CONTROL APPARATUS AND METHOD, AND MOTOR USING THE SAME

(71) Applicant: SAMSUNG ELECTRO-MECHANICS CO., LTD., Suwon, Gyunggi-do (KR)

(72) Inventor: Soo Woong LEE, Gyunggi-do (KR)

(73) Assignee: SAMSUNG ELECTRO-MECHANICS CO., LTD., Suwon (KR)

(21) Appl. No.: 13/779,353

(22) Filed: Feb. 27, 2013

(30) Foreign Application Priority Data
Dec. 6, 2012 (KR) 10-2012-0140925

(51) Int. Cl. H02P 23/00

(52) U.S. Cl. CPC H02P 23/00
USPC 318/400.22

(57) ABSTRACT

There are provided a motor driving control apparatus and method and a motor using the same, the motor driving control apparatus including: a driving signal generating unit generating a driving control signal controlling a driving of a motor apparatus, a back-electromotive force detecting unit detecting back-electromotive force generated in the motor apparatus, and a controlling unit estimating a driving current of the motor apparatus using the back-electromotive force and adjusting a duty ratio of the driving control signal when the estimated driving current is an overcurrent.

### CROSS-REFERENCE TO RELATED APPLICATIONS

This application claims the priority of Korean Patent Application No. 10-2012-0140925 filed on Dec. 6, 2012, in the Korean Intellectual Property Office, the disclosure of which is incorporated herein by reference.

### BACKGROUND OF THE INVENTION

1. Field of the Invention

The present invention relates to a motor driving control apparatus and method, and a motor using the same.

2. Description of the Related Art

In accordance with the development of a motor technology, motors having various sizes have been used in a wide range of fields.

Generally, a motor is driven by allowing a rotor to be rotated by a permanent magnet and a coil having polarities changed according to current applied thereto. Initially, a brush type of motor in which a rotor is provided with a coil was provided. However, such a motor has problems such as the abrasion of a brush, the generation of sparks, and the like, caused due to driving thereof.

Therefore, recently, various types of brushless motor have generally been used. In the brushless motor, a rotor is provided with a permanent magnet and a stator is provided with a plurality of coils to induce rotation of the rotor.

In controlling these various motors, an overcurrent needs to be commonly controlled. That is, in the case in which driving current is excessively provided at the time of controlling the motor, since the driving or durability of the motor may be unstable, it may be important to prevent an overcurrent in the driving of the motor.

To this end, a separate overcurrent detection circuit has been used in the related art. However, in this method, a control circuit of the motor has been increased and showed a tendency towards due to the overcurrent detection circuit, such that demand for miniaturization of the motor in accordance with the miniaturization of an electronic product has not been satisfied.

The following Related Art Documents, which relate to the brushless motor, have a limitation that they do not solve the above-mentioned problem.

### RELATED ART DOCUMENT

(Patent Document 1) Korean Utility Model Laid-Open Publication No. 1999-0033903
(Patent Document 2) Korean Patent Laid-Open Publication No. 2008-0090192

### SUMMARY OF THE INVENTION

An aspect of the present invention provides a motor driving control apparatus and method capable of simplifying a configuration of a circuit and stably correcting an overcurrent by estimating whether or not an overcurrent has been generated in a motor using back-electromotive force of the motor and adjusting a duty ratio of a control signal at the time of generation of the overcurrent, and a motor using the same.

According to an aspect of the present invention, there is provided a motor driving control apparatus including: a driving signal generating unit generating a driving control signal controlling a driving of a motor apparatus; a back-electromotive force detecting unit detecting back-electromotive force generated in the motor apparatus; and a controlling unit estimating a driving current of the motor apparatus using the back-electromotive force and adjusting a duty ratio of the driving control signal when the estimated driving current is an overcurrent.

The controlling unit may estimate the driving current from a magnitude of the back-electromotive force using a proportional relationship between the back-electromotive force and the driving current.

The controlling unit may include a table storage unit storing a correspondence relationship between the back-electromotive force and the driving current; and an overcurrent detector estimating a magnitude of the driving current corresponding to the back-electromotive force provided from the back-electromotive force detecting unit using the table storage unit to determine whether the estimated magnitude of the driving current is an overcurrent.

The controlling unit may further include a duty controller controlling the driving signal generating unit to change a duty ratio of the driving control signal when the driving signal is determined to be the overcurrent.

The duty controller may determine a duty ratio to be changed in proportion to a difference between a predetermined reference current and the overcurrent.

The motor driving control apparatus may further include an inverter unit providing a current to each of a plurality of phases included in the motor apparatus according to the driving control signal.

The back-electromotive force detecting unit may include a plurality of back-electromotive force detectors connected to the inverter unit and the plurality of respective phases.

The back-electromotive force detecting unit may detect the back-electromotive force using a back-electromotive force detector connected to a phase that is not currently operated, among the plurality of back-electromotive force detectors connected to the inverter unit and the plurality of respective phases.

According to another aspect of the present invention, there is provided a motor including: a motor apparatus performing a rotation operation according to a driving control signal; and a motor driving control apparatus providing the driving control signal to the motor apparatus to control a driving of the motor apparatus and determining whether an overcurrent has been generated in the motor apparatus using back-electromotive force detected in the motor apparatus.

The motor driving control apparatus may include: a driving signal generating unit generating a driving control signal; a back-electromotive force detecting unit detecting the back-electromotive force; and a controlling unit estimating a driving current of the motor apparatus using the back-electromotive force and adjusting a duty ratio of the driving control signal when the estimated driving current is an overcurrent.

The controlling unit may estimate the driving current from a magnitude of the back-electromotive force using a proportional relationship between the back-electromotive force and the driving current.

According to another aspect of the present invention, there is provided a motor driving control method performed in a motor driving control apparatus controlling a driving of a motor apparatus, the motor driving control method including: detecting back-electromotive force of the motor apparatus; estimating a driving current of the motor apparatus using the detected back-electromotive force; and determining whether the estimated driving current is an overcurrent and adjusting a duty ratio of a driving control signal of the motor apparatus when the driving current is an overcurrent.

The estimating of the driving current may include estimating a magnitude of the driving current corresponding to the back-electromotive force using a proportional relationship between the back-electromotive force and the driving current.

The adjusting of the duty ratio may include: calculating a difference between a predetermined reference current and the driving current; and calculating a duty ratio to be reduced using the calculated difference.

The adjusting of the duty ratio may further include reflecting the calculated duty ratio to generate a driving control signal of the motor apparatus.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a motor driving control apparatus;

FIG. 2 is a schematic circuit diagram illustrating an example of an overcurrent detecting unit of FIG. 1;

FIG. 3 is a configuration diagram illustrating an example of a motor driving control apparatus according to an embodiment of the present invention;

FIG. 4 is a schematic circuit diagram illustrating an example of a back-electromotive force detecting unit of FIG. 3;

FIG. 5 is a reference graph showing a relationship between driving current and back-electromotive force;

FIG. 6 is a block diagram illustrating an example of a controlling unit of FIG. 3;

FIG. 7 is a schematic circuit diagram illustrating an example of the controlling unit of FIG. 3; and

FIG. 8 is a flow chart for describing an example of a motor driving control method according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Hereinafter, for convenience of explanation, the present invention will be described based on a brushless motor. However, since this is for convenience of explanation, it is obvious that the scope of the present invention is not necessarily limited to the brushless motor.

In addition, hereinafter, a motor will be denoted itself as a motor apparatus 20 or 200, and an apparatus including a motor driving control apparatus 10 or 100 for driving the motor apparatus 20 or 200 and the motor apparatus 20 or 200 will be denoted as a motor.

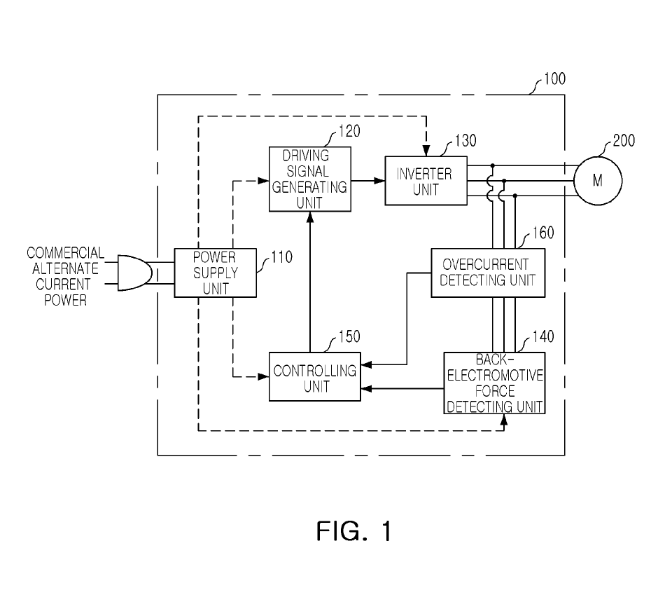

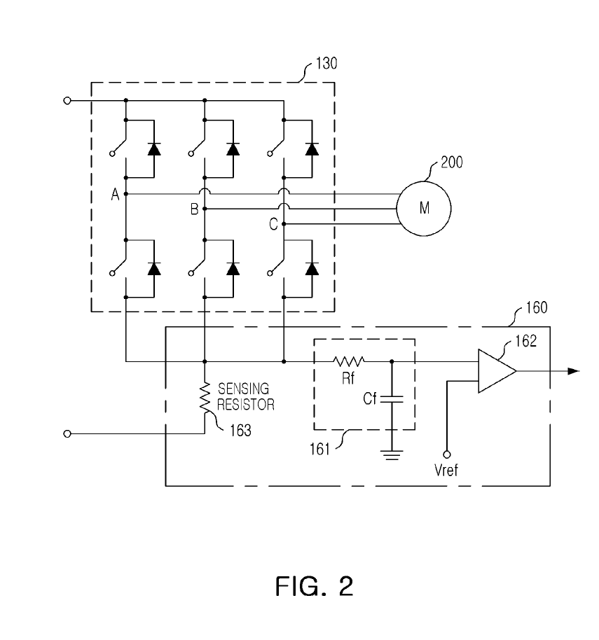

FIG. 1 is a configuration diagram illustrating an example of a motor driving control apparatus. FIG. 2 is a schematic circuit diagram illustrating an example of an overcurrent detecting unit of FIG. 1.

Referring to FIGS. 1 and 2, the motor driving control apparatus 100 may include a power supply unit 110, a driving signal generating unit 120, an inverter unit 130, a back-electromotive force detecting unit 140, a controlling unit 150, and an overcurrent detecting unit 160.

The power supply unit 110 may supply power to respective components of the motor driving control apparatus 100. For example, the power supply unit 110 may convert a commercial alternate current (AC) voltage into a direct current (DC) voltage and supply the DC voltage to the respective components. In FIGS. 1 and 2, a dotted line denotes that predetermined power is supplied from the power supply unit 110.

The driving signal generating unit 120 may provide a driving control signal to the inverter unit 130.

In the embodiment of the present invention, the driving control signal may be a pulse width modulation (PWM) signal. In this case, the driving signal generating unit 120 may apply a variable DC level to a predetermined reference waveform (for example, a triangular wave) to adjust a duty ratio of the PWM signal. For example, as a DC level closer to a low voltage level of the triangular wave is applied, the duty ratio of the PWM signal is increased.

The inverter unit 130 may control an operation of the motor apparatus 200. For example, the inverter unit 130 may convert a DC voltage into a plural-phase (for example, a three-phase or a four-phase) voltage according to the driving control signal and apply the plural-phase voltage to respective coils (corresponding to the plural phase) of the motor apparatus 200.

The back-electromotive force detecting unit 140 may detect back-electromotive force of the motor apparatus 200.

The controlling unit 150 may control the driving signal generating unit 120 to generate the driving control signal using the back-electromotive force provided from the back-electromotive force detecting unit 140. For example, the controlling unit 150 may control the driving signal generating unit 120 to perform phase commutation at a zero-crossing point of the back-electromotive force.

The overcurrent detecting unit 160 may detect whether a driving current of the motor apparatus 200 is an overcurrent. The overcurrent detecting unit 160 may stop the driving of the motor apparatus 200 when the overcurrent has been generated.

As shown in FIG. 2, the overcurrent detecting unit 160 may include a low pass filter 161, a comparator 162, and a sensing resistor 163. More specifically, the overcurrent detecting unit 160 may convert a current flowing in the motor apparatus 200 into a voltage using the sensing resistor 163 and allow the voltage to pass through the low pass filter 161 configured of a resistor Rf and a capacitor Cf. The voltage filtered by the low pass filter 161 is compared with a predetermined reference voltage, and when the filtered voltage is identical to or higher than the reference voltage, a gate driver (not shown) is turned off.

The motor apparatus 200 may perform a rotation operation according to the driving control signal. For example, the motor apparatus 200 may generate magnetic fields in the respective coils of the motor apparatus 200 by currents provided by the inverter unit 130 and flowing in the respective phases. A rotor included in the motor apparatus 200 may be rotated by the magnetic fields generated in the respective coils as described above.

However, in FIGS. 1 and 2, since the overcurrent detecting unit 160 is separately required, a size of a motor driving circuit may be increased, and a configuration thereof may be complicated. In addition, in the case in which an overcurrent is detected, since the gate driver is turned off to thereby stop the driving of the motor apparatus 200, the motor apparatus 200 may not be stably driven but may be discontinuously driven, such that power consumption may be increased.

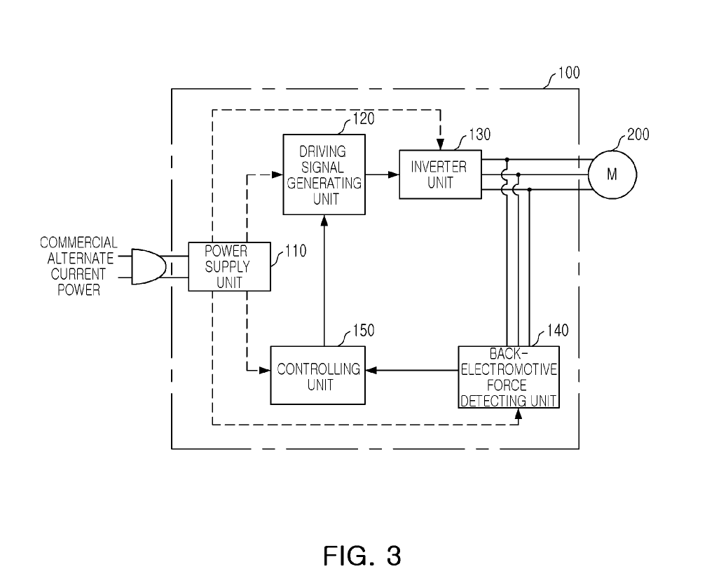

Hereinafter, various embodiments of the present invention will be described with reference to FIGS. 3 through 8.

In a description of various embodiments of the present invention to be described below, overlapped descriptions of contents that are the same as or correspond to contents described above with reference to FIGS. 1 and 2 will be omitted. However, those skilled in the art may clearly understand detailed contents of the present invention from the above-mentioned description.

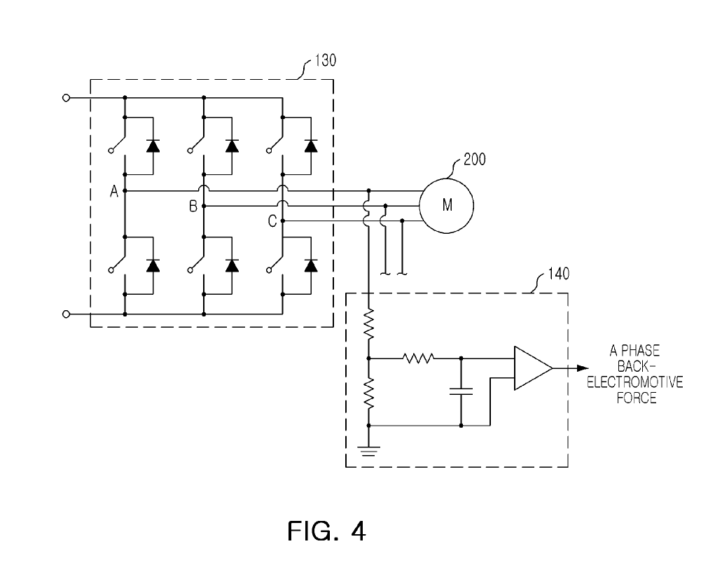

FIG. 3 is a configuration diagram illustrating an example of a motor driving control apparatus according to an embodiment of the present invention; and FIG. 4 is a schematic circuit diagram illustrating an example of a back-electromotive force detecting unit of FIG. 3.

Referring to FIGS. 3 and 4, the motor driving control apparatus 100 may include the power supply unit 110, the driving signal generating unit 120, the inverter unit 130, the back-electromotive force detecting unit 140, and the controlling unit 150.

The power supply unit 110 may supply power to the respective components of the motor driving control apparatus 100.

The driving signal generating unit 120 may generate a driving control signal of the motor apparatus 200 according to a control of the controlling unit 150. For example, the driving signal generating unit 120 may generate a pulse width modulation signal (hereinafter, referred to as a PWM signal) having a predetermined duty ratio and provide the PWM signal to the inverter unit 130 to allow the motor apparatus 200 to be driven.

The inverter unit 130 may provide a driving current to each of the plurality of phases of the motor apparatus 200 according to the driving control signal.

The back-electromotive force detecting unit 140 may detect back-electromotive force generated in the motor apparatus 200.

In the embodiment of the present invention, the back-electromotive force detecting unit 140 may include a plurality of back-electromotive force detectors connected to the plurality of phases of the motor apparatus 200. The back-electromotive force detector may be commonly connected to any one of the plurality of phases and the inverter unit 130. While a single back-electromotive force detector for a single phase (A phase) is shown in FIG. 4, the invention is not limited thereto. The back-electromotive detecting unit may include the respective back-electromotive detector for all of the three phases shown in FIG. 4.

In the embodiment of the present invention, the back-electromotive force detecting unit 140 may detect back-electromotive force using a back-electromotive force detector connected to a phase that is not currently operated.

The reason is that in the case in which a rotor is rotated by a phase to which the driving current is currently provided, the back-electromotive force is induced in the phase that is not currently operated.

The controlling unit 150 may estimate the driving current of the motor apparatus using the back-electromotive force. That is, the back-electromotive force and the driving current may have a proportional relationship with each other, and the controlling unit 150 may estimate the driving current from the back-electromotive force using this proportional relationship.

The controlling unit 150 may adjust the duty ratio of the driving control signal when the estimated driving current corresponds to the overcurrent.

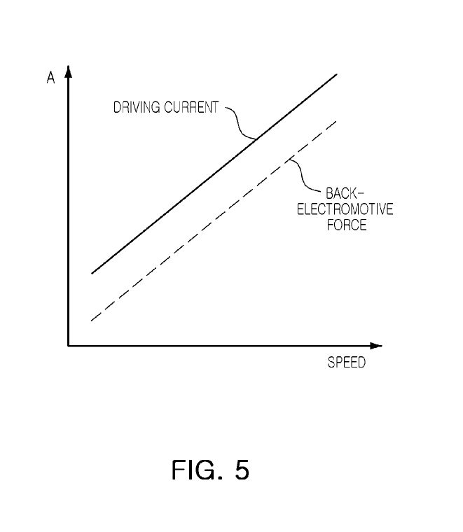

The controlling unit 150 will be described below in more detail with reference to FIGS. 5 through 7.

FIG. 5 is a reference graph showing a relationship between driving current and back-electromotive force.

Referring to the graph of FIG. 5, it may be appreciated that the back-electromotive force and the driving current are in proportion to each other. The reason is that the as the driving current is greater, a rotational speed of the rotor of the motor apparatus is faster, and the rotational speed of the rotor is faster, the electromotive force induced by rotation is greater.

Therefore, according to the present invention, the driving current may be estimated from the back-electromotive force using this fact, that is, the proportional relationship between the back-electromotive force and the driving current, such that whether or not the overcurrent has been generated may be determined without a separate overcurrent detecting circuit.

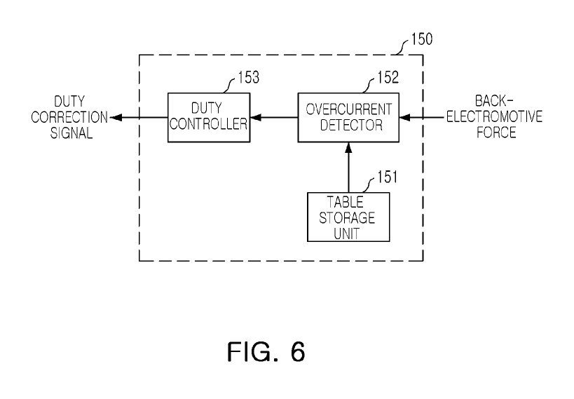

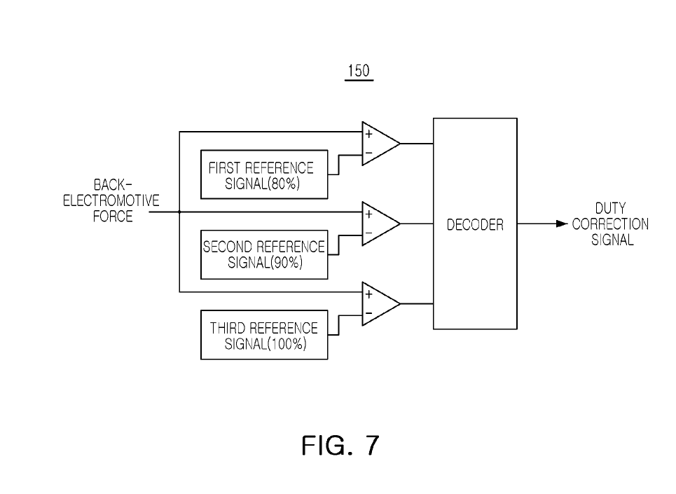

FIG. 6 is a block diagram illustrating an example of a controlling unit of FIG. 3; and FIG. 7 is a schematic circuit diagram illustrating an example of the controlling unit of FIG. 3.

Referring to FIGS. 3, 6, and 7, the controlling unit 150 may include a table storage unit 151, an overcurrent detector 152, and a duty controller 153.

The table storage unit 151 may store a correspondence relationship between the detected back-electromotive force and the driving current.

The overcurrent detector 152 may estimate a magnitude of the driving current corresponding to the back-electromotive force provided by the back-electromotive force detecting unit using the table storage unit 151. The overcurrent detector 152 may determines whether the estimated magnitude of the driving current corresponds to an overcurrent.

The duty controller 153 may control the driving signal generating unit 120 to change the duty ratio of the driving control signal when the driving current is determined to be an overcurrent.

TABLE 1

| | Duty Ratio of | | Back- | | |
|---|---|---|---|---|---|
| | Driving Control | | Electromotive | | Driving |
| | Signal | Speed | Force | | Current |
| 1 | | 100 rpm | 100 | mV | 10 mA |
| 64 | 60% | 6000 rpm | 3 | V | 600 mA |
| 80 | 70% | 7000 rpm | 3.5 | V | 700 mA |
| 96 | 80% | 8000 rpm | 4 | V | 800 mA |
| 112 | 90% | 9000 rpm | 4.5 | V | 900 mA |
| 128 | 100% | 10000 rpm | 5 | V | 1000 mA |

Table 1 is a table showing an example of relationships between the speed, the duty ratio of the driving control signal, the back-electromotive force, and the driving current. In the example of Table 1, when it is assumed that the motor apparatus 200 is a motor operated at up to 10000 rpm, the state in which the driving current is 80% or less of 1 A may be determined to be a normal state, and the state in which the driving current is more than 80% of 1 A may be determined to be an overcurrent state.

The overcurrent detector 152 may estimate the driving current corresponding to the received back-electromotive force unit using the table storage unit 151. For example, in the case in which a level of the received back-electromotive force is 4.5 V, the overcurrent detector 152 may estimate that the driving current is 900 mA.

The overcurrent detector 152 may determine that the estimated driving current is an overcurrent, and the duty controller 153 may output a duty correction signal so as to adjust the duty ratio corresponding thereto.

The duty controller 153 may determine a duty ratio to be changed in proportion to a difference between the predetermined reference current and the overcurrent. Describing the duty controller 153 with reference to the above-mentioned example, since the driving current is 900 mA, and the current driving control signal has a duty ratio of 90%, the duty controller 153 may calculate a duty correction value so that the driving current is in a stable normal state, that is, so that the duty ratio is 80% or less. That is, in the above-mentioned example, the duty correction value becomes 10%, and the duty controller 153 may output the duty correction signal so as to reduce the duty ratio by 10%.

Here, the duty controller 153 may provide a DC level used to generate the pulse width modification signal as the duty correction signal. Therefore, the duty controller 153 may provide the DC level by which the voltage is increased according to the duty ratio to be reduced to the driving signal generating unit 120, and the driving signal generating unit 120 may generated a pulse width modification signal by synthesizing this DC level with a predetermined reference signal (triangular wave, or the like).

In the schematic circuit diagram shown in FIG. 7, first to third reference signals may serve as the table storage unit 151, and a decoder may serve as the overcurrent detector 152 and the duty controller 153.

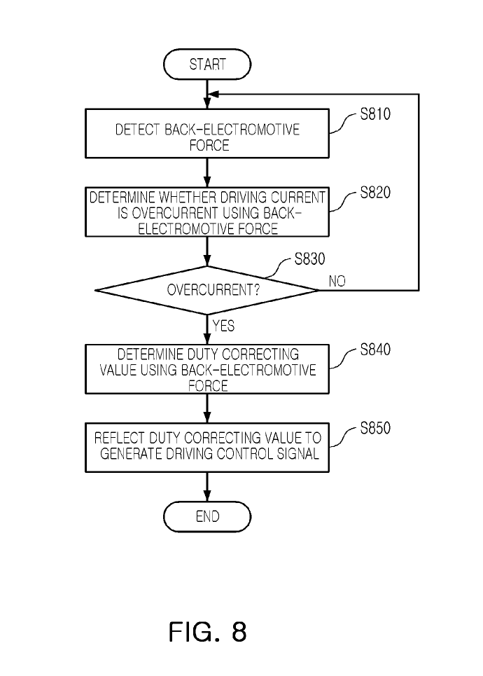

FIG. 8 is a flow chart for describing an example of a motor driving control method according to the embodiment of the present invention.

Hereinafter, an example of a motor driving control method according to the embodiment of the present invention will be described with reference to FIG. 8. Since the example of the motor driving control method according to the embodiment of the present invention is performed in the motor driving control apparatus 100 described above with reference to FIGS. 3 through 7, an overlapped description for contents that are the same as or correspond to the above-mentioned contents will be omitted.

Referring to FIG. 8, the motor driving control apparatus 100 may detect the back-electromotive force of the motor apparatus 200 (S810).

The motor driving control apparatus 100 may estimate a driving current of the motor apparatus 200 using the detected back-electromotive force and confirm whether the driving current is an overcurrent (in an overcurrent state) using the estimated magnitude of the driving current (S820).

If the driving current is an overcurrent (S830, Yes), the motor driving control apparatus 100 may calculate a duty correction value and reflect the duty correction value to generate a driving control signal (S840, S850).

If the driving current is not an overcurrent (S830, No), the motor driving control apparatus 100 may repeatedly perform operations S810 to S830.

In an example of S820, the motor driving control apparatus 100 may estimate a magnitude of the driving current corresponding to a level of the back-electromotive force using the proportional relationship between the back-electromotive force and the driving current.

In an example of S840, the motor driving control apparatus 100 may calculate a difference between the predetermined reference current and the driving current to calculate a duty ratio to be reduced (duty correction value) using the calculated difference.

In an example of S850, the motor driving control apparatus 100 may reflect the duty ratio (the duty correction value) calculated in S840 to generate the driving control signal of the motor apparatus 200.

As set forth above, according to the embodiment of the present invention, the configuration of the circuit can be simplified and the generated overcurrent can be stably corrected by estimating whether or not an overcurrent has been generated in the motor using back-electromotive force of the motor and adjusting the duty ratio of the control signal at the time of generation of overcurrent.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a driving signal generating unit generating a driving control signal controlling a driving of a motor apparatus;
a back-electromotive force detecting unit detecting back-electromotive force generated in the motor apparatus; and
a controlling unit estimating a driving current of the motor apparatus using the back-electromotive force and adjusting a duty ratio of the driving control signal when the estimated driving current is an overcurrent.

2. The motor driving control apparatus of claim 1, wherein the controlling unit estimates the driving current from a magnitude of the back-electromotive force using a proportional relationship between the back-electromotive force and the driving current.

3. The motor driving control apparatus of claim 1, wherein the controlling unit includes a table storage unit storing a correspondence relationship between the back-electromotive force and the driving current; and
an overcurrent detector estimating a magnitude of the driving current corresponding to the back-electromotive force provided from the back-electromotive force detecting unit using the table storage unit to determine whether the estimated magnitude of the driving current is an overcurrent.

4. The motor driving control apparatus of claim 3, wherein the controlling unit further includes a duty controller controlling the driving signal generating unit to change a duty ratio of the driving control signal when the driving signal is determined to be the overcurrent.

5. The motor driving control apparatus of claim 4, wherein the duty controller determines a duty ratio to be changed in proportion to a difference between a predetermined reference current and the overcurrent.

6. The motor driving control apparatus of claim 1, further comprising an inverter unit providing a current to each of a plurality of phases included in the motor apparatus according to the driving control signal.

7. The motor driving control apparatus of claim 6, wherein the back-electromotive force detecting unit includes a plurality of back-electromotive force detectors connected to the inverter unit and the plurality of respective phases.

8. The motor driving control apparatus of claim 7, wherein the back-electromotive force detecting unit detects the back-electromotive force using a back-electromotive force detector connected to a phase that is not currently operated, among the plurality of back-electromotive force detectors connected to the inverter unit and the plurality of respective phases.

9. A motor comprising:
a motor apparatus performing a rotation operation according to a driving control signal; and
a motor driving control apparatus providing the driving control signal to the motor apparatus to control a driving of the motor apparatus and determining whether an overcurrent has been generated in the motor apparatus using back-electromotive force detected in the motor apparatus.

10. The motor of claim 9, wherein the motor driving control apparatus includes:
a driving signal generating unit generating a driving control signal;
a back-electromotive force detecting unit detecting the back-electromotive force; and
a controlling unit estimating a driving current of the motor apparatus using the back-electromotive force and adjusting a duty ratio of the driving control signal when the estimated driving current is an overcurrent.

11. The motor of claim 10, wherein the controlling unit estimates the driving current from a magnitude of the back-electromotive force using a proportional relationship between the back-electromotive force and the driving current.

12. A motor driving control method performed in a motor driving control apparatus controlling a driving of a motor apparatus, the motor driving control method comprising:
detecting back-electromotive force of the motor apparatus;
estimating a driving current of the motor apparatus using the detected back-electromotive force; and
determining whether the estimated driving current is an overcurrent and adjusting a duty ratio of a driving control signal of the motor apparatus when the driving current is an overcurrent.

13. The motor driving control method of claim 12, wherein the estimating of the driving current includes estimating a magnitude of the driving current corresponding to the back-electromotive force using a proportional relationship between the back-electromotive force and the driving current.

14. The motor driving control method of claim 12, wherein the adjusting of the duty ratio includes:
calculating a difference between a predetermined reference current and the driving current; and
calculating a duty ratio to be reduced using the calculated difference.

15. The motor driving control method of claim 14, wherein the adjusting of the duty ratio further includes reflecting the calculated duty ratio to generate a driving control signal of the motor apparatus.
